(19) United States
(12) Patent Application Publication
(10) Pub. No.: US 2020/0158027 A1
(43) Pub. Date: May 21, 2020

(54) FLAMEOUT RISK MITIGATION IN ENGINES

(71) Applicant: PRATT & WHITNEY CANADA CORP., Longueuil (CA)

(72) Inventors: Yen-Wen WANG, Boucherville (CA); Jason HERBORTH, Acton (CA); Tony YEE, Brossard (CA)

(21) Appl. No.: 16/571,396

(22) Filed: Sep. 16, 2019

Related U.S. Application Data
(63) Continuation-in-part of application No. 16/195,750, filed on Nov. 19, 2018.

(51) Int. Cl. F02C 9/28

(52) U.S. Cl. CPC F02C 9/28; F05D 2270/311

(57) ABSTRACT

Systems and methods for mitigating flameout risk in an engine of an aircraft are provided. A humidity value is obtained from a humidity sensor associated with the engine. A flameout risk for the engine is determined based on the humidity value. The flameout risk is compared to a predetermined risk threshold. When the flameout risk is above the predetermined risk threshold, a rate of fuel flow to the engine is increased.

### CROSS-REFERENCE TO RELATED APPLICATIONS

The present application is a continuation-in-part of U.S. patent application Ser. No. 16/195,750, filed Nov. 19, 2018, the entire content of which is incorporated herein by reference.

### TECHNICAL FIELD

The application relates generally to aircraft engines, and more particularly to techniques for operating aircraft engines.

### BACKGROUND OF THE ART

An engine flameout refers to unintended shutdown of an engine due to the extinction of flames in the combustion chamber. In some cases, inclement weather conditions may be responsible for an engine flameout, for example due to ingested ice or water during a rain storm and/or a hail storm. For this reason, there are various techniques used to avoid engine flameout.

Existing approaches relate to techniques for pre-emptively detecting inclement weather, and applying suitable countermeasures in response thereto. However, inclement weather detection schemes may fail, or may not detect inclement weather sufficiently quickly to be effective.

As such, there is room for improvement.

### SUMMARY

In accordance with at least one broad aspect, there is provided a method for mitigating flameout risk in an engine of an aircraft. A humidity value is obtained from a humidity sensor associated with the engine. A flameout risk for the engine is determined based on the humidity value. The flameout risk is compared to a predetermined risk threshold. When the flameout risk is above the predetermined risk threshold, a rate of fuel flow to the engine is increased.

In accordance with at least one other broad aspect, there is provided a system for mitigating flameout risk in an engine of an aircraft. The system comprises a processing unit; and a non-transitory computer-readable medium coupled to the processing unit and comprising computer-readable program instructions. The computer-readable program instructions are executable by the processing unit for: obtaining a humidity value from a humidity sensor associated with the engine; determining, based on the humidity value, a flameout risk for the engine; comparing the flameout risk to a predetermined risk threshold; and when the flameout risk is above the predetermined risk threshold, increasing a rate of fuel flow to the engine

### DESCRIPTION OF THE DRAWINGS

Reference is now made to the accompanying figures in which:

FIG. 1 is a cutaway side elevational view of an example engine;

FIGS. 2A-B and 3A-B are cutaway and zoomed views, respectively, of different humidity sensors of the engine of FIG. 1;

FIG. 4 is a block diagram of an example system for operating an engine of an aircraft;

FIG. 5 is block diagram of an example computing device for implementing at least part of the system of FIG. 4; and

FIG. 6 illustrate a flowchart of an example method for operating an engine of an aircraft.

### DETAILED DESCRIPTION

There is described herein methods and systems for operating an engine of an aircraft. In some embodiments, the particular techniques used to operate the engine include techniques for limiting, reducing, and/or managing the risk of flameout. An engine flameout refers to unintended shutdown of an engine due to the extinction of flames in the combustion chamber, and can occur during inclement weather. Inclement weather refers to any weather condition which may have an adverse effect on the operation of the engine. Examples of inclement weather include, but are not limited to, rain, hail, ice, sleet, snow, freezing rain, and/or a combination thereof. Inclement weather also includes atmospheric conditions in the vicinity of the engine having adverse effects on the operation of the engine, including operation in high-moisture environments, for example in a cloud.

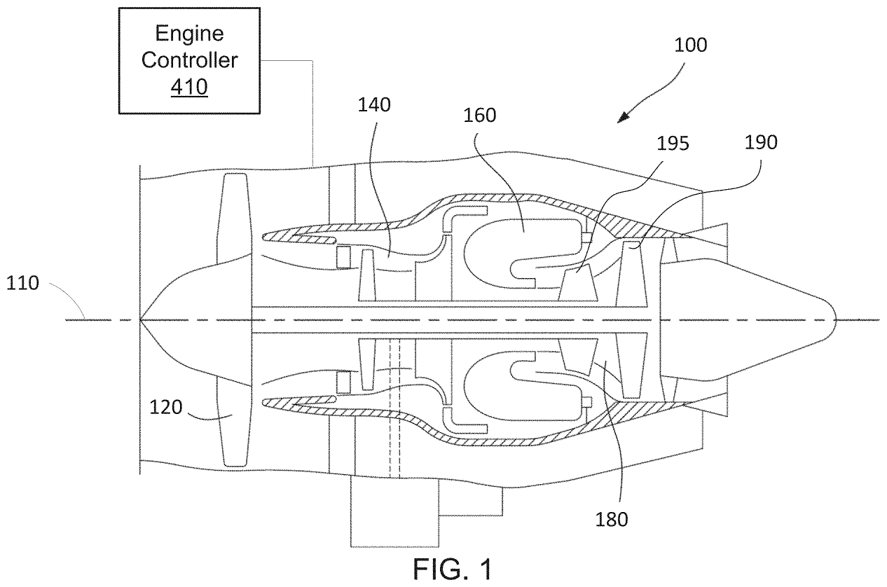

FIG. 1 illustrates a gas turbine engine 100 to which the detection methods and systems may be applied. Note that while engine 100 is a turbofan engine, the detection methods and systems may be applicable to turboprop, turboshaft, and other types of gas turbine engines. In addition, the engine 100 may be an auxiliary power unit (APU), an auxiliary power supply (APS), a hybrid engine, or any other suitable type of engine.

Engine 100 generally comprises in serial flow communication: a fan 120 through which ambient air is propelled, a compressor section 140 for pressurizing the air, a combustor 160 in which the compressed air is mixed with fuel and ignited for generating an annular stream of hot combustion gases, and a turbine section 180 for extracting energy from the combustion gases. Axis 110 defines an axial direction of the engine 100. In some embodiments, a low pressure spool is composed of a low pressure shaft and a low pressure turbine. The low pressure shaft drives the propeller 120. A high pressure spool is composed of a high pressure turbine attached to a high pressure shaft, which is connected to the compressor section 140. It should be noted that other configurations for the engine 100 are also considered.

Control of the operation of the engine 100 can be effected by one or more control systems, for example an engine controller 410. The engine controller 410 can modulate a fuel flow rate provided to the operating engine 100, the position and/or orientation of variable geometry mechanisms within the engine 100, a bleed level of the engine 100, and the like. Alternatively, or in addition, the engine controller 410 can alter the fuel supply to the engine 100, which can include changing a type of fuel or the makeup of a blend of one or more fuels supplied to the engine 100. For example, at one time, the engine 100 can be supplied with biofuel at a given rate of flow, and at a different time, the engine 100 can be supplied with Jet-A fuel at the same given rate of flow, or at a different rate of flow. Still other approaches are considered.

In addition, while the engine 100 is shown as being a gas turbine for an aircraft, it should be noted that the embodiments described herein can apply to any suitable gas turbine engine, including primary engines, auxiliary engines, or to any engine of any suitable vehicle, generator, and the like. In some embodiments, controllers and other devices within the engine 100, for example sensors, are dual-channel devices, in which separate channels are used for data acquisition and data transmission.

As part of the control of the engine 100, the engine controller 410 can assess a flameout risk for the engine 100, for example based on a humidity level in the vicinity of, the engine 100. As used herein, the term “vicinity” can refer to locations within the engine 100, locations on an outer surface of the engine 100, locations directly in front of, behind, above, below, beside, or otherwise adjacent to the engine 100, whether in contact therewith or not, locations elsewhere on an aircraft or other vehicle to which the engine 100 is coupled, or any other suitable location. In accordance with embodiments of the present disclosure, the engine 100 can be equipped with one or more sensors which provide information about the environmental conditions in which the engine 100 is operating, which can assist in assessing the flameout risk for the engine 100.

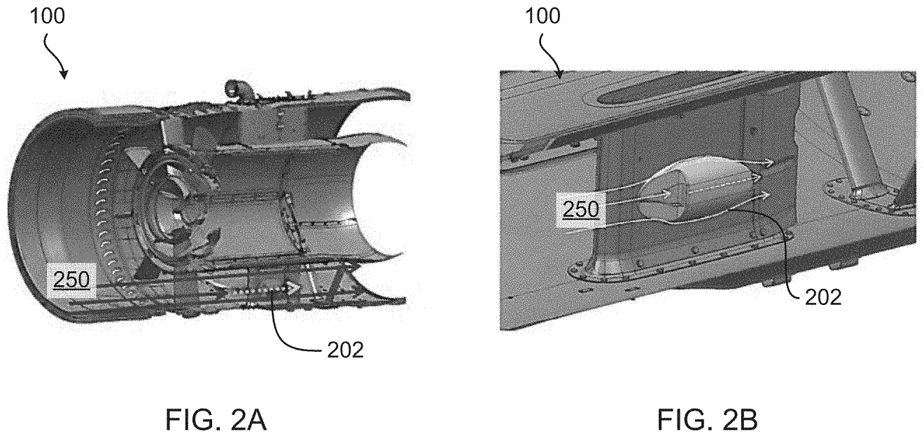

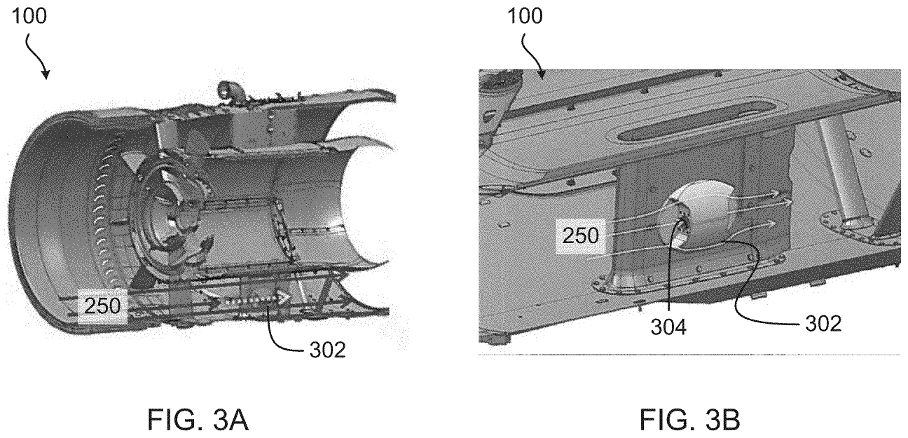

With reference to FIGS. 2A-B, in order to house the sensors, in one embodiment a NACA-style inlet scoop 202 can be installed in a nacelle of the engine 100. Air within the nacelle flows in the direction of arrows 250, and some of the air is captured by the inlet scoop 202, which can house therein one or more sensors. The sensors can then detect various characteristics of the air, including a humidity level, a temperature, a rate of flow, and the like.

With reference to FIGS. 3A-B, in another embodiment a flow-through-style inlet 302 can be installed in the nacelle of the engine 100. The inlet 302 defines an inner cavity 304 in which one or more sensors can be located. The sensors can then detect similar characteristics as those detected by the sensors in the inlet scoop 202. It should be noted that other approaches for housing the sensors are also considered.

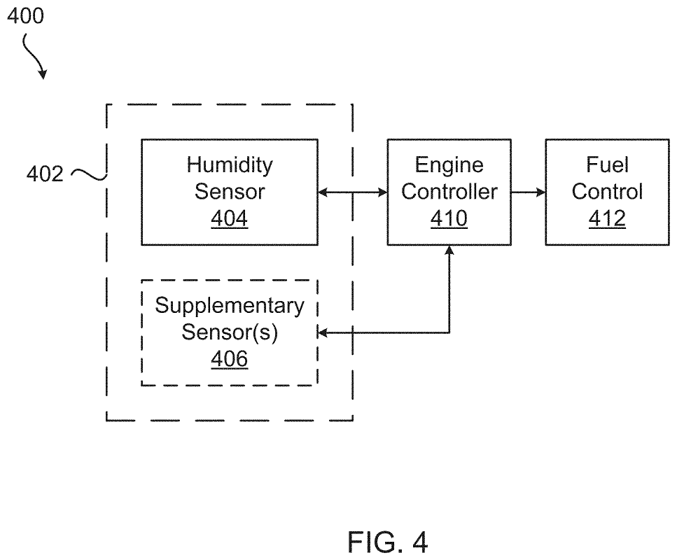

With reference to FIG. 4, a schematic diagram of system 400 for operating an engine, for example the engine 100, is shown. The system 400 is composed of sensors 402, an engine controller 410, and a fuel control 412. The sensors 402 are communicatively coupled to the engine controller 410, and the engine controller 410 is communicatively coupled to the fuel control 412.

It should be noted that each of the elements of the system 400, including the sensors 402, the engine controller 410, and the fuel control 412, can be disposed within, adjacent to, or otherwise proximate to the engine 100. In some embodiments, the sensors 402 are located within the engine 100, within a nacelle of the engine 100, for instance as shown in FIGS. 2A-B and 3A-B, or at any other suitable location. In other embodiments, the sensors 402 can be located elsewhere in an aircraft or other vehicle to which the engine 100 is coupled. In some embodiments, the engine controller 410 is wiredly coupled to the sensors 402 and/or the fuel control 412, and can be located within the engine 100 or proximate to the engine 100, for example within an aircraft which is powered by the engine 100. In other embodiments, the engine controller is wirelessly coupled to the sensors 402 and/or the fuel control 412. The fuel control 412 can be disposed within the engine 100 or proximate thereto. For example, the fuel control 412 can include a fuel flow valve or fuel injection system, which can be disposed within the engine 100 or proximate thereto, as appropriate.

The sensors 402 include at least a humidity sensor 404. The humidity sensor 404 is configured for measuring an ambient humidity level in the vicinity of the engine 100. In one embodiment, the humidity sensor 404 is configured for measuring the humidity level in air within, or proximate to, the engine 100. The humidity sensor 404 can be located within the engine 100, within a nacelle of the engine 100, for example within the inlet scoop 202 of FIGS. 2A-B or the inlet 302 of FIGS. 3A-B, which can be disposed within the nacelle, within a bypass duct of the engine 100, or at any other suitable location. The humidity sensor 404 can measure the humidity level of air in the engine 100, for example using a sample of the air within the engine 100. In another embodiment, the humidity sensor 404 is disposed on an outer surface of the engine 100, or a nacelle thereof, and the humidity sensor 404 can measure the humidity in the air outside the engine 100, for example using a sample of the air outside the engine 100. Other approaches are also considered.

Optionally, the sensors 402 include one or more supplementary sensors 406, which can be one or more of a temperature sensor, a pressure sensor, a particulate sensor, and the like. For example, a temperature sensor can be used to measure an ambient temperature within the engine 100, or in a vicinity of the engine 100. In another example, a pressure sensor can be used to measure an ambient pressure within the engine 100, or in a vicinity of the engine 100. In a further example, a particulate sensor can be used to measure an amount and/or a concentration of certain particulates in the air within the engine 100, or in the air in the vicinity of the engine 100. Still other types of sensors can be included in the supplementary sensor 406.

The sensors 402 are thus configured for acquiring data about the environmental conditions in which the engine 100 is operating, including a humidity level and optionally including a temperature, a pressure, etc. The sensors 402 can communicate the data to the engine controller 410 using any suitable wired and/or wireless communication means, and using any suitable format and encoding protocols. The data includes at least an indication of a humidity level, but can include additional information, including indications of temperature, pressure, and the like.

In some embodiments, the sensors 402 provide data to the engine controller 410 substantially in real-time. For example, the sensors 402 can operate on a predetermined polling frequency, and can provide data to the engine controller on a schedule commensurate with the polling frequency for the sensors 402. In some other embodiments, the sensors 402 provide data to the engine controller 410 in response to certain triggers: for instance, the sensors 402 can provide data to the engine controller 410 in response to changes in the parameters being measured by the sensors 402, or in response to the parameters exceeding or falling below certain predetermined thresholds. In still other embodiments, the sensors 402 can be polled for data by the engine controller 410, for example by sending a request from the engine controller 410 to the sensors 402 for data. The sensors 402 can then respond to the engine controller 410 with data, which can include instantaneous values, a listing of one or more previous values, or any other suitable data.

The engine controller 410 can obtain the sensor data from the sensors 402, including at least an indication of a humidity level within or proximate to the engine 100 from the humidity sensor 404, and optionally indication(s) of a temperature, a pressure, and the like, within or proximate the engine 100 from the supplementary sensor(s) 406. The engine controller 410 can then determine, at least based on the humidity level, a flameout risk for the engine 100.

In some embodiments, the engine controller 410 can use the humidity level to assess whether inclement weather conditions are present in the vicinity of the engine 100, thereby contributing to high flameout risk. In other embodiments, the engine controller 410 can use the humidity level to assess whether clement weather conditions are present in the vicinity of the engine 100, thereby reducing the risk of flameout. In some embodiments, the engine controller 410 assesses the risk of flameout for the engine 100 as being low or high relative to one or more predetermined risk level(s), and engine controller 410 can modulate the operation of the engine 100, for example via the fuel control 412, to improve fuel efficiency for the engine 100 and/or to mitigate the risk of flameout for the engine 100.

In some embodiments, the determination of whether the flameout risk is below or above a predetermined risk level is made based on one or more predetermined thresholds for data acquired from the sensors 402. For example, the humidity level for the engine 100 can be compared to a predetermined threshold: when the humidity level is below the threshold, the flameout risk is considered below the predetermined risk level; conversely, when the humidity level is above the threshold, the flameout risk is considered above the predetermined risk level. In another example, two different thresholds can be defined, one lower threshold and one higher threshold: when the humidity level is below the lower threshold, the flameout risk is considered below the predetermined risk level, when the humidity level is between the lower and higher thresholds, the flameout risk is considered below a first risk level, and when the humidity level is above the higher threshold, the flameout risk is considered above a second, higher risk level. The engine controller 410 can then modulate operation of the engine 100, including adjusting a fuel flow rate and/or a type or blend of fuel for the engine 100 via the fuel control 412, based on the flameout risk relative to one or more predetermined risk levels. In other embodiments, the flameout risk can be considered to be above or below predetermined risk levels based on predetermined ranges for the humidity level. Other approaches are also considered.

Predetermined thresholds, ranges, etc., can also be defined for the data received from the supplementary sensor(s), for instance thresholds for temperature, pressure, and the like. The indications provided by each of the sensors 402 can be used to define different flameout risks: a humidity-based flameout risk, a temperature-based flameout risk, a pressure-based flameout risk, etc., each of which can be compared to different predetermined risk levels. In some embodiments, the different flameout risks are combined using an algorithm or other mathematical approach to produce a holistic flameout risk, which can be compared to a predetermined holistic risk level for the engine 100. In some embodiments, the algorithm can weight all flameout risks equally, and in other embodiments, the algorithm can weight one flameout risk, for example the humidity-based flameout risk, more heavily than other flameout risks. Other approaches are also considered.

During operation, the engine controller 410 can continuously monitor the data obtained by the sensors 402, and adjust operation of the engine 100 accordingly. The engine controller 410 is configured for repeating various controlling operations as frequently as necessary, in order to appropriately balance flameout risk mitigation and fuel efficiency for the engine 100.

In some embodiments, the engine controller 410 is further configured for controlling operation of the engine 100 in other ways. For example, the engine controller 410 can effect control of the position of variable geometry mechanisms (variable inlets, guide vanes, and the like), adjust fuel-to-air ratios for the engine 100, alter the position of a bleed-off valve, and effect change in any other suitable operating condition of the engine 100. Additional elements may be coupled to the engine controller 410 in order for the engine controller 410 to effect control of the operation of the engine 100.

In some embodiments, the engine controller 410 can implement one or more artificial intelligence (AI) algorithms for evaluating flameout risk based on the data provided by the sensors 402. The AI can be implemented using any suitable techniques, including machine learning, neural networks, deep learning, and the like. For instance, an AI algorithm can be trained on a dataset of humidity levels, temperature, pressure, etc., captured during aircraft flight, alongside empirical evaluations of whether flameout occurred. By training the AI algorithm on the dataset, the AI algorithm can learn to assess flameout risk, and determine whether the flameout risk for the engine 100 is above or below one or more predetermined risk level(s) based on the environmental conditions in which the engine 100 operates.

The engine controller 410 can be implemented in various manners, such as in software on a processor, on a programmable chip, on an Application Specific Integrated Chip (ASIC), or as a hardware circuit. In some embodiments, the engine controller 410 is implemented in hardware on a dedicated circuit board located inside an Electronic Engine Controller (EEC) or an Engine Control Unit (ECU). The EEC or ECU may be provided as part of a Full Authority Digital Engine Control (FADEC) of an aircraft. In some cases, a processor may be used to communicate information to the engine controller 410, for example within the sensors 402. In other embodiments, the engine controller 410 is implemented in a digital processor of any suitable type.

It should be noted that although the foregoing discussion focused primarily on adjustments to the operation of the engine 100 via operation of the engine controller 410, other embodiments are also considered. For example, the engine controller 410 can be communicatively coupled to an operator control for the aircraft or other vehicle to which the engine 100 is coupled. The operator control can feature one or more display panels, indicator lights, alerts, and the like. The engine controller 410 can be configured for communicating to an operator, via the operator control, that the flameout risk is below, or above, or between, one or more predetermined risk levels, based on the humidity level, the temperature, the pressure, and the like. The engine controller 410 can further elicit from the operator a response, for example an adjustment of the fuel flow rate to the engine 100 and/or the fuel type or blend supplied to the engine 100, as appropriate. In some cases, the engine controller 410 can suggest, via the operator control, a fuel flow rate, a fuel type, and/or a fuel blend for the engine 100. In some other cases, the engine controller 410 can propose a fuel flow rate, a fuel type, and/or a fuel blend for the engine 100, and the operator can confirm the suggestion(s) via the operator control. Still other approaches are considered.

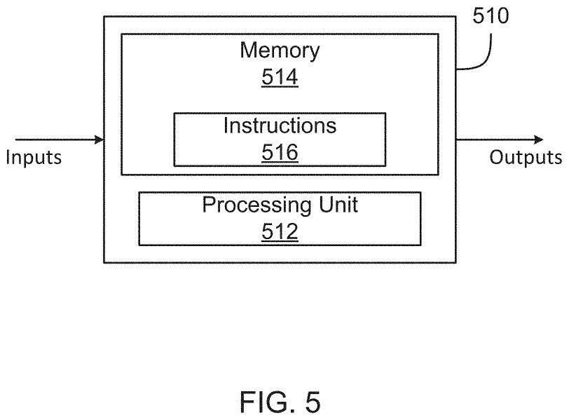

With reference to FIG. 5, the engine controller 410 may be embodied by a computing device 510 configured for implementing the functionality of the engine controller 410. The computing device 510 comprises a processing unit 512 and a memory 514 which has stored therein computer-executable instructions 516. The processing unit 512 may comprise any suitable devices configured to implement the functionality of the engine controller 410 such that instructions 516, when executed by the computing device 510 or other programmable apparatus, may cause the functions/acts/steps performed by the engine controller 410 as described herein to be executed. The processing unit 512 may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory 514 may comprise any suitable known or other machine-readable storage medium. The memory 514 may comprise non-transitory computer readable storage medium, for example, but not limited to, an electronic, magnetic, optical, electromagnetic, infrared, or semiconductor system, apparatus, or device, or any suitable combination of the foregoing. The memory 514 may include a suitable combination of any type of computer memory that is located either internally or externally to device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 514 may comprise any storage means (e.g., devices) suitable for retrievably storing machine-readable instructions 516 executable by processing unit 512.

It should be noted that the computing device 510 may be implemented as part of a FADEC or other similar device, including electronic engine control (EEC), engine control unit (EUC), and the like. In addition, it should be noted that the techniques described herein can be performed by the engine controller 410 substantially in real-time, during operation of the engines 100, for example during a flight mission.

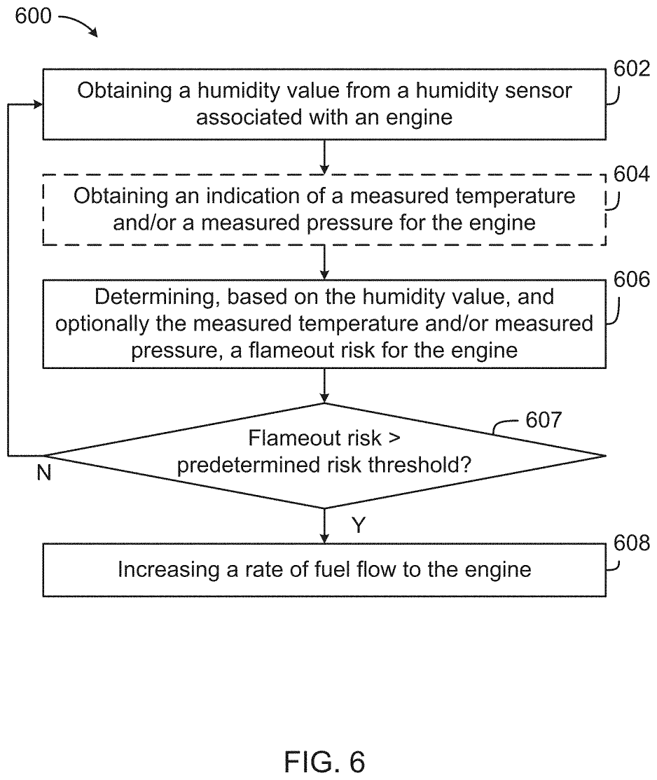

With reference to FIG. 6, the engine controller 410 can be configured for implementing a method 600. At step 602, a humidity value is obtained from a humidity sensor associated with an engine, for instance the humidity sensor 404 associated with the engine 100. For example, the humidity sensor 404 can communicate a humidity value to the engine controller 410. The humidity value can be encoded in any suitable fashion, and be provided to the engine controller 410 using any suitable protocol. Optionally, at step 604, additional data, including one or more indications of a measured temperature, a measured pressure, a particulate count, and the like, is obtained, for instance from one or more of the supplementary sensor(s) 406. The indications of additional measured values can be provided to the engine controller 410 using any suitable encoding and/or protocols.

At step 606, a flameout risk for the engine 100 is determined, based on at least the humidity value, and optionally based on the measured temperature, measured pressure, and the like. The flameout risk can be determined using any suitable algorithms, programs, schedules, and the like. In addition, the flameout risk can be expressed in any suitable fashion. For example, the flameout risk can be expressed as an percent-risk of flameout. In another example, the flameout risk can be expressed as one or more qualitative values, for instance “low”, “medium”, “high”, and the like, Other approaches for expressing the flameout risk are also considered.

At decision step 607, a determination is made regarding whether the flameout risk is greater than a predetermined risk threshold. The risk threshold can be based on any suitable algorithm, statistical program, and the like, including, for example, an artificial intelligence algorithm, or any other suitable methodology. If the flameout risk is above the predetermined risk threshold, the method 600 proceeds to step 608. If the flameout risk is not above the predetermined risk threshold, the method 600 can return to some previous step, for example step 602.

At step 608, following the determination that the flameout risk is above the predetermined risk threshold, a fuel flow rate of the engine is increased. The fuel flow rate can be increased to any suitable amount, for instance based on one or more predetermined schedules. In some embodiments, the increase in the fuel flow rate is based on the flameout risk, or on a difference between the flameout risk and the predetermined risk threshold. For example, if the flameout risk is only slightly above the risk threshold, the fuel flow rate is increased by a small amount, and if the flameout risk is considerably above the risk threshold, the fuel flow rate is increased by a larger amount. Other embodiments are also considered.

In addition, the steps described hereinabove relate to fuel flow rates for the engine 100; however, it should be understood that similar steps may be implemented for control of the engine 100 with different fuel types, blends, and the like. Other embodiments are also considered.

The systems and methods described herein may be implemented in a high level procedural or object oriented programming or scripting language, or a combination thereof, to communicate with or assist in the operation of a computer system, for example the computing device 510. Alternatively, the methods and systems described herein may be implemented in assembly or machine language. The language may be a compiled or interpreted language. Program code for implementing the methods and systems described herein may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and systems described herein may also be considered to be implemented by way of a non-transitory computer-readable storage medium having a computer program stored thereon. The computer program may comprise computer-readable instructions which cause a computer, or more specifically the processing unit 512 of the computing device 510, to operate in a specific and predefined manner to perform the functions described herein, for example those described in the method 600.

Computer-executable instructions may be in many forms, including program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure.

Various aspects of the systems and methods described herein may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments. Although particular embodiments have been shown and described, it will be apparent to those skilled in the art that changes and modifications may be made without departing from this invention in its broader aspects. The scope of the following claims should not be limited by the embodiments set forth in the examples, but should be given the broadest reasonable interpretation consistent with the description as a whole.

1. A method for mitigating flameout risk in an engine of an aircraft, comprising:
obtaining a humidity value from a humidity sensor associated with the engine;
determining, based on the humidity value, a flameout risk for the engine;
comparing the flameout risk to a predetermined risk threshold; and
when the flameout risk is above the predetermined risk threshold, increasing a rate of fuel flow to the engine.

2. The method of claim 1, wherein determining the flameout risk comprises determining the presence of inclement weather in the vicinity of the aircraft based on the humidity value.

3. The method of claim 2, wherein determining the presence of inclement weather comprises determining the presence of at least one of rain, snow, sleet, and hail.

4. The method of claim 1, further comprising obtaining an indication of a measured temperature for the engine from a temperature sensor associated with the engine, and wherein the flameout risk is further determined based on the measured temperature.

5. The method of claim 1, further comprising obtaining an indication of a measured pressure for the engine from a pressure sensor associated with the engine, and wherein the flameout risk is further determined based on the measured pressure.

6. The method of claim 1, wherein obtaining the humidity value from the humidity sensor comprises obtaining a reading from the humidity sensor indicative of a humidity level outside the engine.

7. The method of claim 1, wherein obtaining the humidity value from the humidity sensor comprises obtaining a reading from the humidity sensor indicative of a humidity level inside the engine.

8. The method of claim 7, wherein the reading is indicative of a humidity level inside a nacelle of the engine.

9. The method of claim 7, wherein the reading is indicative of a humidity at an inlet of the engine.

10. The method of claim 7, wherein the reading is indicative of a humidity in a bypass duct of the engine.

11. A system for mitigating flameout risk in an engine of an aircraft, comprising:
a processing unit; and
a non-transitory computer-readable medium coupled to the processing unit and comprising computer-readable program instructions executable by the processing unit for:
obtaining a humidity value from a humidity sensor associated with the engine;
determining, based on the humidity value, a flameout risk for the engine;
comparing the flameout risk to a predetermined risk threshold; and
when the flameout risk is above the predetermined risk threshold, increasing a rate of fuel flow to the engine.

12. The system of claim 11, wherein determining the flameout risk comprises determining the presence of inclement weather in the vicinity of the aircraft based on the humidity value.

13. The system of claim 12, wherein determining the presence of inclement weather comprises determining the presence of at least one of rain, snow, sleet, and hail.

14. The system of claim 11, wherein the program instructions are further executable for obtaining an indication of a measured temperature within the engine from a temperature sensor associated with the engine, and wherein the flameout risk is further determined based on the measured temperature.

15. The system of claim 11, wherein the program instructions are further executable for obtaining an indication of a measured pressure within the engine from a pressure sensor associated with the engine, and wherein the flameout risk is further determined based on the measured pressure.

16. The system of claim 11, wherein obtaining the humidity value from the humidity sensor comprises obtaining a reading from the humidity sensor indicative of a humidity level outside the engine.

17. The system of claim 11, wherein obtaining the humidity value from the humidity sensor comprises obtaining a reading from the humidity sensor indicative of a humidity level inside the engine.

18. The system of claim 17, wherein the reading is indicative of a humidity level inside a nacelle of the engine.

19. The system of claim 17, wherein the reading is indicative of a humidity at an inlet of the engine.

20. The system of claim 17, wherein the reading is indicative of a humidity in a bypass duct of the engine.
